(19) United States
(12) Patent Application Publication
(10) Pub. No.: US 2006/0137995 A1
(43) Pub. Date: Jun. 29, 2006

(54) Method for removal of metal from a workpiece

(76) Inventors: Sukanta Ghosh, West Bengal (IN); Brian Charles Blakey, Niskayuna, NY (US); Thodla Ramgopal, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/025,146

(22) Filed: Dec. 29, 2004

(51) Int. Cl. B23H 7/34

(52) U.S. Cl. 205/674

(57) ABSTRACT

A method for removal of material from a workpiece is disclosed. The method comprises the steps of providing a workpiece; providing an electrolyte, the electrolyte comprising hydrogen peroxide, in an amount of at least about 6 weight percent, and a source of hydroxyl ions; and contacting the workpiece with the electrolyte. The method provides the key advantage of high quality surface finish of the workpiece.

### BACKGROUND OF THE INVENTION

The invention is related to a method of removal of metal from a workpiece. More particularly, the invention is related to chemical and electrochemical methods of uniformly removing refractory metal from a workpiece.

High performance components in aircraft engine turbo machines such as compressor blades, bearings and gears are typically made of refractory metals and alloys because of their excellent corrosion resistance properties and high strength to weight ratio. Machining and testing of these components often requires material to be removed from the surface. The metal removal should be achieved without pitting and without producing irregularities. Refractory metals and alloys form tenacious and protective passive films on their surfaces. As a result, very aggressive chemical agents, such as hydrofluoric acid, are used for etching refractory materials. Hydrofluoric-based agents pose serious health and safety issues. Therefore, there is a need for safer and more efficient methods for removing material from refractory metal workpieces while avoiding undesirable phenomena such as pitting.

### BRIEF DESCRIPTION OF THE INVENTION

The present invention meets these and other needs.

One embodiment of the invention is a method for removal of material from a workpiece. The method comprises the steps of providing a workpiece, providing an electrolyte, and contacting the workpiece with the electrolyte. The electrolyte comprises hydrogen peroxide in an amount of at least about 6 weight percent, and a source of hydroxyl ions.

### DESCRIPTION OF THE DRAWINGS

These and other features, aspects, and advantages of the present invention will become better understood when the following detailed description is read with reference to the accompanying drawing in which like characters represent like parts throughout the drawing, wherein:

FIG. 1 is a flow diagram of a method for removing material from a workpiece according to one embodiment of the present invention; and

FIG. 2 is a schematic of an electrochemical cell

### DETAILED DESCRIPTION OF THE INVENTION

Various embodiments of this invention have been described in fulfillment of the various needs that the invention meets. It should be recognized that these embodiments are merely illustrative of the principles of various embodiments of the present invention. Numerous modifications and adaptations thereof will be apparent to those skilled in the art without departing from the spirit and scope of the present invention. Thus, it is intended that the present invention cover all suitable modifications and variations as come within the scope of the appended claims and their equivalents.

Refractory metals and alloys are frequently used in critical materials applications because of their excellent corrosion resistance properties and high strength to weight ratio. For example, in the aerospace industry, titanium alloys are used as blade materials in the compressors of jet engines. In the conventional manufacturing process, the blades are forged, which leads to the formation of an oxide scale at the surface of the blade, and an underlying layer of oxygen-rich metal that is 0.05 to 0.2 mm thick. Shot blasting or grinding removes most of the oxide scale, and this step is generally followed by an etching process in a hydrofluoric acid (HF) bath to remove a small thickness of metal, on the order of 10 μm, to facilitate inspection of the blade. In other applications, including non-aerospace applications, refractory metal and alloy surfaces are etched using HF to engrave the surfaces, to clean the surfaces, to achieve a certain aesthetic appearance, or to help differentiate features on surfaces to facilitate metallographic studies. In short, HF-containing solutions are commonly used in aerospace and non-aerospace applications to remove metal from the surfaces of refractory metals and alloys by dissolution.

HF is a highly hazardous chemical, and its use requires special handling. Moreover, hydrogen generated during an HF etching or dissolving process can in some cases lead to hydrogen embrittlement of the metal part. Clearly, there is a need to develop an efficient method for etching and dissolving refractory metal alloys that does not require the use of HF and provides all of the advantages of the HF etch including uniform etching. Disclosed herein is one such method.

The method 100 comprises the steps of providing a workpiece; providing an electrolyte, the electrolyte comprising hydrogen peroxide, in an amount of at least about 6 weight percent, and a source of hydroxyl ions; and contacting the workpiece with the electrolyte.

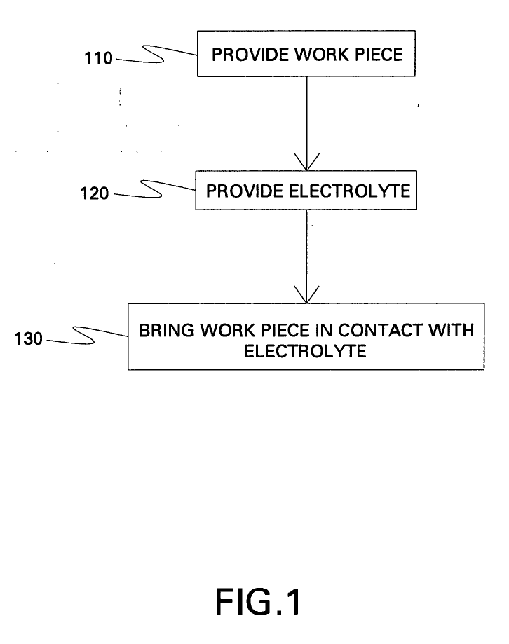

The method 100 summarized in FIG. 1 begins with step 110, in which a workpiece is provided. Metals and alloys, which may be etched in accordance with the present invention include, but are not limited to, metals selected from the group consisting of titanium, vanadium, chromium, zirconium, molybdenum, tungsten, tantalum, hafnium, rhenium, niobium, aluminum, combinations thereof, and alloys thereof. In a particular embodiment, the workpiece comprises titanium, such as, for example, a workpiece made of pure titanium metal, commercially pure titanium, or any titanium alloy. The actual configuration of the workpiece may vary widely. As a general illustration, the substrate may be in the form of a houseware item (e.g., cookware), or a printed circuit board substrate. In many embodiments, the workpiece is in the form of a component of a turbine assembly. Airfoils, including compressor turbine blades, are typical workpieces that are suitable for processing according to embodiments of the present invention. The present invention is useful for removing material from the flat areas of workpieces, as well as from curved or irregular surfaces, including indentations, hollow regions, or holes.

Step 120 involves providing an electrolyte comprising hydrogen peroxide, in an amount of at least about 6 weight percent, and a source of hydroxyl ions. The rate of dissolution of a given metal or alloy depends on the properties of the etch solution, which include temperature, the concentration of hydrogen peroxide, and the concentration of hydroxide ions. In general, the rate of dissolution increases as each of these variables increase, but a careful balance among the variables is often required when etching refractory metals to avoid localized attack, i.e. pitting. In a particular embodiment, hydrogen peroxide is present in an amount in the range from about 6 weight percent to about 50 weight percent. In another embodiment, hydrogen peroxide is present in an amount in the range from about 10 weight percent to about 30 weight percent.

Hydroxyl ions can be obtained from any source known to those skilled in the art, including sodium hydroxide, potassium hydroxide, lithium hydroxide, magnesium hydroxide, calcium hydroxide, and ammonium hydroxide. In one embodiment, the source of hydroxyl ions is present in an amount of at least about 0.5 M. In another embodiment, the hydroxyl ions are present in an amount in the range from about 1M to about 5M. Moreover, in one embodiment, the electrolyte further comprises water; in a particular embodiment, the electrolyte consists essentially of water, hydrogen peroxide and a source of hydroxyl ions. Alternatively, the electrolyte may further comprise other additives to enhance performance, including, for instance, one or more inhibitors, dispersants, surfactants, chelating agents, wetting agents, deflocculants, stabilizers, anti-settling agents, and anti-foam agents.

In step 130, the workpiece is brought in contact with the electrolyte. Any one of several well-known methods, or combinations of individual methods, for contacting solutions with solid surfaces may be applied in embodiments of the present invention, including, but not limited to, spraying, brushing, rolling, immersing, and flowing. Generally the electrolyte temperature is maintained within a desired range while the electrolyte contacts the workpiece, because, as stated above, the temperature of the solution affects the rate of metal dissolution. The temperature of the electrolyte is typically at least about 0 degrees centigrade. In some embodiments, the temperature of the electrolyte is in the range from about 20 degrees centigrade to about 80 degrees centigrade. In particular embodiments, the temperature of the electrolyte is in the range from about 25 degrees centigrade to about 45 degrees centigrade. As the reaction between the electrolyte and workpiece is exothermic, maintaining the temperature within a narrow desired range may require the use of techniques to remove heat from the electrolyte, such as immersing a container holding the electrolyte in an ice bath or other cooling medium, for example. These and other temperature control techniques are well known in the art and are readily applied to embodiments of the present invention.

The contact time may vary considerably, but is usually up to about 72 hours, and in particular embodiments is in the range from about 1 minute to about 1 hour. Comparatively long contact times may compensate for conditions such as low bath temperatures that tend to provide comparatively low removal rates. After removal from the electrolyte (or after contact of the workpiece by any technique mentioned above), the substrate is typically rinsed in water, which also may contain other conventional additives, such as a wetting agent.

The main advantages of the method of the present invention over various other methods encompassing other electrolytes known in the art are the high etch rate, uniform etching of metals or alloys, superior surface finish, and the use of safer and environmentally preferred chemicals.

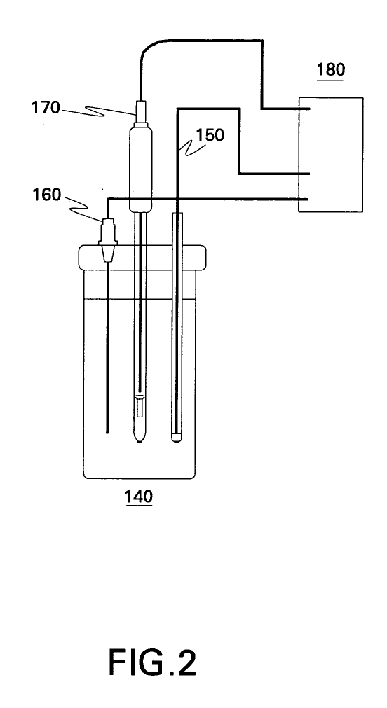

The method may be performed chemically, that is, without the application of current in a chemical bath, for example, or electrochemically in an electrochemical cell. Where the method involves electrochemical processing, providing the workpiece comprises providing an anode in electrical communication with a cathode, wherein the anode comprises the workpiece. FIG. 2 shows a schematic of an electrochemical cell 140 comprising an anode 150, a cathode 160, and an optional reference electrode 170. Electrode 170 may be any reference electrode generally used in the art for electrochemical measurements. An electric current is flowed between the electrodes 150 and 160, generally by application of a potential difference across the electrodes 150, 160 using a power supply 180. In general, the higher the applied current density as measured at the anode (“anodic current density”), the higher the rate of dissolution, but pitting, excessive hydrogen evolution, or both, may become problematic where the anodic current density is set too high. In one embodiment, the anodic current density is greater than about 0.5 mA/cm². In another embodiment, the anodic current density is in the range from about 10 mA/cm² to about 200 mA/cm². In yet another embodiment, the anodic current density is in the range from about 100 mA/cm² to about 150 mA/cm².

### EXAMPLES

The following examples are presented to further illustrate certain embodiments of the present invention. These examples should not be read to limit the invention in any way.

In the following examples both chemical and electrochemical etching were carried out on blades composed of Ti-6Al-4V, a titanium aluminium vanadium alloy, in aqueous electrolytes.

### Example 1

Table 1 summarizes the results of chemical etching conducted on Ti-6Al-4V blades in accordance with embodiments of the present invention, and shows that the etch rate depends on temperature: etch rates are an order of magnitude higher at 40 degrees centigrade vs. 25 degrees centigrade. The rate also depends on the concentrations of peroxide and hydroxide: higher concentrations correspond to higher etch rates. All electrolytes used in this example were aqueous.

TABLE 1
Summary of chemical etching tests on Ti—6Al—4V blades

| | H₂O₂ | NaOH | Temperature | |
|---|---|---|---|---|
| Test | Concentration | Concentration | (degrees | Etch Rate |
| No. | (wt %) | (M) | centigrade) | (mils/10 mins) |
| 1 | 30 | 1 | 40 | 0.14 |
| 2 | 30 | 5 | 40 | 0.27 |
| 3 | 30 | 5 | 25 | 0.06 |
| 4 | 30 | 1 | 25 | 0.02 |
| 5 | 10 | 5 | 40 | 0.14 |
| 6 | 10 | 5 | 25 | 0.04 |

A blade etched by immersion in an aqueous solution of 30 wt % peroxide, 1 M sodium hydroxide at 40 degrees centigrade was metallographically examined in cross-section and compared to a similarly prepared sample that was etched using a conventional HF bath. The surfaces of the two samples appeared to be similar, and no pitting was observed.

### Example 2

A Ti-6Al-4V sample was electrochemically etched in an aqueous solution of 30 vol % H₂O₂ and saturated NaOH. A current density of 150 mA/cm² was passed through the sample for 120 seconds. Metallographic examination of a cross section of the etched sample showed a similar surface finish to that of a sample that had not been etched. No pitting was observed.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for removal of material from a workpiece, the method comprising the steps of:
(a) providing a workpiece;
(b) providing an electrolyte, said electrolyte comprising hydrogen peroxide, in an amount of at least about 6 weight percent, and a source of hydroxyl ions; and
(c) contacting said workpiece with said electrolyte.

2. The method according to claim 1, wherein said workpiece comprises a metal selected from the group consisting of Ti, V, Cr, Zr, Mo, W, Ta, Hf, Re, Nb, Al, combinations thereof, and alloys thereof.

3. The method according to claim 1, wherein said hydrogen peroxide is present in an amount in the range from about 6 weight percent to about 50 weight percent.

4. The method according to claim 3, wherein said hydrogen peroxide is present in an amount in the range from about 10 weight percent to about 30 weight percent.

5. The method according to claim 1, wherein said source of hydroxyl ions is present in an amount of at least about 0.5 M.

6. The method according to claim 5, wherein said source of hydroxyl ions is present in an amount in the range from about 1M to about 5M.

7. The method according to claim 1, wherein said source of hydroxyl ions comprises a hydroxide of at least one selected from the group consisting of Na, K, Li, Mg, Ca, and NH.

8. The method according to claim 1, wherein contacting comprises maintaining a temperature of said electrolyte of at least 0 degree centigrade.

9. The method according to claim 8, wherein said temperature of said electrolyte is in the range from about 25 degrees centigrade to about 45 degrees centigrade.

10. The method according to claim 1, wherein said electrolyte further comprises water.

11. The method according to claim 1, wherein contacting said workpiece with said electrolyte comprises at least one of spraying, brushing, rolling, immersing, and flowing

12. The method according to claim 1, wherein providing said workpiece comprises providing an anode in electrical communication with a cathode, wherein said anode comprises said workpiece.

13. The method according to claim 12, further comprising flowing an electric current between said anode and said cathode.

14. The method according to claim 13, wherein said electric current has an anodic current density greater than about 0.5 mA/cm².

15. The method according to claim 14, wherein said anodic current density is in the range from about 10 mA/cm² to about 200 mA/cm².

16. The method according to claim 15, wherein said anodic current density is in the range from about 100 mA/cm² to about 150 mA/cm².

17. A method for removing material from a workpiece, the method comprising the steps of:
(a) providing a workpiece, wherein said workpiece comprises Ti;
(b) providing an electrolyte, said electrolyte comprising:
1. water,
2. hydrogen peroxide, in a concentration of at least about 6 weight percent, and
3. a hydroxide of at least one selected from the group consisting of Na, K, Li, Mg, Ca, NH₄, wherein said hydroxide is present in a range from about 0.5M to about 5M; and
(c) contacting said workpiece with said electrolyte.

18. A method for removing material from a workpiece, the method comprising the steps of:
(a) providing an anode in electrical communication with a cathode, wherein said anode comprises a workpiece comprising titanium;
(b) providing an electrolyte, said electrolyte comprising
1. water,
2. hydrogen peroxide, in a concentration of at least about 6 weight percent, and
3. a hydroxide of at least one selected from the group consisting of Na, K, Li, Mg, Ca, NH₄ wherein said hydroxide is present in a range from about 0.5M to about 5M;
(c) immersing said anode and said cathode in said electrolyte; and
(d) flowing an electric current having an anodic current density in the range from about 100 mA/cm² to about 150 mA/cm² between said anode and said cathode.
